(19) United States
(12) Patent Application Publication
(10) Pub. No.: US 2018/0035170 A1
(43) Pub. Date: Feb. 1, 2018

(54) METHOD AND DEVICE FOR CONTROLLING PLAYING STATE

(71) Applicant: Beijing Xiaomi Mobile Software Co., Ltd., Beijing (CN)

(72) Inventors: Tong LIU, Beijing (CN); Yu Lu, Beijing (CN); Xingsheng Lin, Beijing (CN)

(21) Appl. No.: 15/658,849

(22) Filed: Jul. 25, 2017

(30) Foreign Application Priority Data
Jul. 28, 2016 (CN) PCT/CN2016/092099

(51) Int. Cl. H04N 21/472; G06T 11/60; H04N 21/4402; H04N 21/422; H04N 21/414

(52) U.S. Cl. CPC H04N 21/47217; H04N 21/42204; H04N 21/41407; H04N 21/4402; G06T 11/60; G06F 3/02

(57) ABSTRACT

A method for controlling a playing state, includes: upon receipt of a starting event triggered by a peripheral component of a smart device, acquiring rotating information of the smart device; and controlling a playing state of content which is currently being played, according to the starting event and the rotating information.

### CROSS-REFERENCE TO RELATED APPLICATIONS

This application is based upon and claims priority to PCT Application No. PCT/CN2016/092099, filed on Jul. 28, 2016, the entire contents of which are incorporated herein by reference.

### TECHNICAL FIELD

The present disclosure generally relates to the technical field of communication and computer processing, and more particularly, to a method and a device for controlling a playing state.

### BACKGROUND

With development of electronic technology, mobile phones, televisions, and computers have become popular. Moreover, various devices are equipped with video playing features. Control of a playing progress of a video may be implemented in various ways, such as by pressing a hardware button on a remote controller.

Conventionally, when a user is watching a video, the user may fast forward through an uninteresting part of the video, and play fast backward an interesting part or a missing part of the video. Control of playing fast forward or backward may be implemented through a corresponding button on a remote controller. For a device with a touch screen, control of playing fast forward or backward may be implemented by dragging a sliding block on a progress bar in an interface. However, in case there is no fast forward or backward playing button on a remote controller, or it is inconvenient for the user to operate a touch screen, the conventional methods may not be applicable.

### SUMMARY

In a first aspect of the present disclosure, there is provided a method for controlling a playing state, comprising: upon receipt of a starting event triggered by a peripheral component of a smart device, acquiring rotating information of the smart device; and controlling a playing state of content which is currently being played, according to the starting event and the rotating information.

In a second aspect of the present disclosure, there is provided a terminal for controlling a playing state, comprising: a processor; and a memory for storing instructions executable by the processor; wherein the processor is configured to: upon receipt of a starting event triggered by a peripheral component of a smart device, acquire rotating information of the smart device; and control a playing state of content which is currently being played, according to the starting event and the rotating information.

In a third aspect of the present disclosure, there is provided a non-transitory computer-readable storage medium having stored therein instructions that, when executed by a processor of a terminal, cause the terminal to perform a method for controlling a playing state, the method comprising: upon receipt of a starting event triggered by a peripheral component of a smart device, acquiring rotating information of the smart device; and controlling a playing state of content Which is currently being played, according to the starting event and the rotating information.

It is to be understood that both the foregoing general description and the following detailed description are exemplary only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for controlling a playing state according to an exemplary embodiment.

FIG. 2 is a flow chart of a method for controlling a playing state according to an exemplary embodiment.

FIG. 3 is a flow chart of a method for controlling a playing state according to an exemplary embodiment.

FIG. 4 is a flow chart of a method for controlling a playing state according to an exemplary embodiment.

FIG. 5 is a block diagram of a device for controlling a playing state according to an exemplary embodiment.

FIG. 6 is a block diagram of a device for controlling a playing state according to an exemplary embodiment.

FIG. 7 is a block diagram of a device for con rolling a playing state according to an exemplary embodiment.

FIG. 8 is a block diagram of an acquiring module according to an exemplary embodiment.

FIG. 9 is a block diagram of an acquiring module according to an exemplary embodiment.

FIG. 10 is a block diagram of a device for controlling a playing state according to an exemplary embodiment.

FIG. 11 is a block diagram of a device for controlling a playing state according to an exemplary embodiment.

FIG. 12 is a block diagram of a device for controlling a playing state according to an exemplary embodiment.

FIG. 13 is a block diagram of a device for controlling a playing state according to an exemplary embodiment.

FIG. 14 is a block diagram of a device according to an exemplary embodiment.

FIG. 15 is a block d n of a device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

In exemplary embodiments of the present disclosure, there are provided methods for controlling fast forward playing of a video by obtaining rotating information of a device when the device is rotated. The methods do not require many control buttons and do not require user operation performed on a touch screen, and can provide convenience for a user to control fast playing of the video.

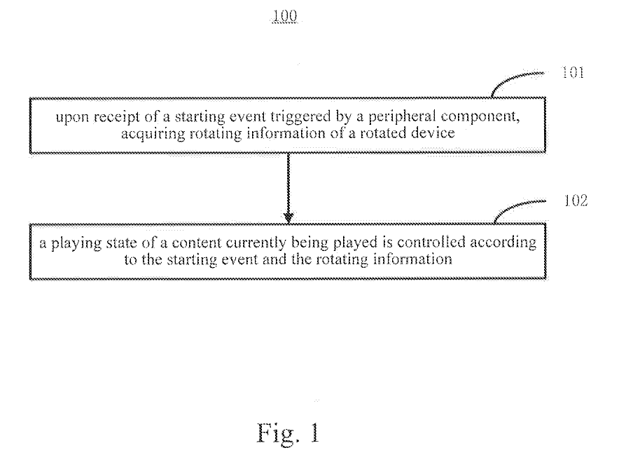

FIG. 1 is a flow chart of a method 100 for controlling a playing state, according to an exemplary embodiment. For example, the method 100 may be implemented by a terminal with video and/or audio playing features, such as a mobile terminal. Referring to FIG. 1, the method 100 includes the following steps.

At step 101, upon receipt of a starting event triggered by a peripheral component, rotating information of a rotated device is acquired.

At step 102, a playing state of a content currently being played is controlled according to the starting event and the rotating information.

In the embodiment, the rotated device may be the terminal, or a smart device operating with the terminal, such as a pair of virtual reality (VR) glasses. The peripheral component may be a button on the terminal or the smart device, a joystick or other components. The starting event may be a button event when the button is triggered, or a joystick rotating event of the joystick. The content may be a video or an audio file. The playing state may include a playing speed, a playing angle, or a playing direction, and so on.

In the embodiment, the playing state of the content may be controlled by the terminal according to the rotating information. Moreover, by controlling based on both conditions of the starting event of the peripheral component and the rotating information, it can accurately control fast forward playing of the content, and reduce the probability of false control.

For example, when controlling fast forward playing of a video through a button, the method 100 may be implemented by obtaining rotating information of the rotated device upon receipt of a button event triggered through the button. The video which is being currently played is controlled to be fast played according to the button event and the rotating information. Compared with the conventional methods in which the control is based on a single condition, e.g., only pressing a single button, the method 100 can more accurately control the video.

If the rotating information is acquired before receipt of the button event triggered through the button, other kinds of controls of the video may be performed according to the rotating information. Once a button event triggered through the button is received, the terminal will switch to the control of fast forward playing of the video.

In the embodiment, at step 101, the rotating information may be obtained continuously. Fast forward playing of the video may be controlled according to the continuously obtained rotating information, if a rotation operation is stopped and no more rotating information is obtained, or the rotating information obtained is null, fast forward playing of the video may be ceased.

In one embodiment, the button event may include: an event of long press on one or more buttons, an event of double clicking one or more buttons, or an event of clicking multiple buttons. The button event may be of various kinds, and, ay be applicable to various application scenarios.

For example, when the button event is an event of long press on one or more buttons, and when a long press operation is started, the control of fast forward playing of the video is started, and when long press operation stops, the fast forward playing of the video is ceased.

For example, when the button event is an event of double clicking one or more buttons, or an event of clicking multiple buttons, the control of fast forward playing of the video is started when the button event occurs a first time. When the same button event occurs again, that is, the same set of one or more buttons are double clicked again, or the same set of multiple buttons are clicked again, the fast forward playing of the video is ceased.

When the fast forward playing of the video is ceased, acquiring rotating information may be ceased. Alternatively, the rotating information may continue o be acquired.

In one embodiment, the peripheral component may be a physical button disposed outside of a housing of the terminal or the smart device, or may be a physical button on a remote control device, e.g., a joystick, bound with the smart device. The starting event may be triggered by operating the physical button, which may be applicable to various application scenarios.

in one embodiment, the peripheral component may be a virtual button displayed on the terminal or the smart device, or may be a virtual button displayed on the remote control device bound with the smart device. The starting event may be triggered by touching the virtual button, which may be applicable to various application scenarios.

The method 100 may be performed by a terminal, such as a mobile terminal, a personal computer, a television, and so on. The button may be a button of a virtual reality (VR) wearable display device (e.g., VR glasses), a mobile terminal, a remote control stick, and so on.

For example, when the method 100 is performed by a mobile terminal, a virtual button or a physical button of the mobile terminal may be triggered, and it may be considered that the mobile terminal receives a button event. Also for example, the mobile terminal is connected to a pair of VR glasses (in a wired or wireless way), in this case, when a button on the VR glasses is clicked, or pressed for an extended period, the VR glasses may send the button event generated through the triggered button to the mobile terminal. Then, the mobile terminal may receive the button event. The mobile terminal may acquire rotating information according to the rotation of the mobile terminal, and control fast playing of the video according to the button and the rotating information.

As another example, the VR glasses may acquire a button event generated through a button of the VR glasses, or through a remote control stick. The VR glasses may send the button event to the mobile terminal, and the mobile terminal may control fast playing of the video according the received button event.

In one embodiment, step 101 includes step A1. At step A1, the rotating information is acquired through a sensor inside the smart device, which may provide a flexible control method applicable to various application scenarios.

In one embodiment, step 101 includes step A2. At step A2, the rotating information is acquired through a remote control device bound with the smart device, which may provide a flexible control method applicable to various application scenarios.

In the embodiments, the rotating information may be acquired through sensor inside the smart device, or may be acquired through an external device. For example, the rotating information may be acquired through a bound VR wearable display device (e.g., VR glasses), or acquired through a bound mobile terminal, or acquired through a bound remote control stick.

In the embodiments, the device for generating a button event, the device for acquiring the rotating information, and the device for controlling playing of the video may be the same device, or may be different devices.

For example, a virtual button or a physical button of the mobile terminal may be triggered, and it may be considered that the mobile terminal receives a button event. The mobile terminal may acquire rotating information through rotation of the mobile terminal. The mobile terminal may take charge of controlling playing of the video. Therefore, the mobile terminal controls fast playing of the video according to the button event generated by the mobile terminal and the rotating information acquired by the mobile terminal.

Also for example, the pair of VR glasses receives a button event through a button of the pair of VR glasses, and the pair of VR glasses contains a sensor such as a gyroscope, and acquires rotating information through rotation of the pair of VR glasses. In this case, the mobile terminal may take charge of controlling playing of the video. The VR glasses may send the button event and the rotating information to the mobile terminal. Then, the mobile terminal may control fast playing of the video according to the received button event and rotating information.

In the embodiments, the button event and the rotating information are used to trigger the fast playing of the video. Fast playing may not necessarily be controlled at a time instance, and may be controlled for a continuous time period. During continuously control of fast playing, the fast playing may be controlled according to continuously acquired rotating information.

In one embodiment, the rotating information includes direction information for controlling a playing direction of the content currently being played. The direction of fast playing of the video currently being displayed may be controlled according to the rotating direction information.

The rotating direction information may include rotating leftward or rotating rightward. For example, rotating leftward means controlling fast backward playing of the video, and rotating rightward means controlling fast forward playing of the video.

The rotating direction information may include rotating upward or rotating downward. For example, rotating upward means controlling fast backward playing of the video, and rotating downward means controlling fast forward playing of the video.

A corresponding relationship between the rotating direction information and the direction of fast playing may be set in advance, or may be configured by a user as desired.

In one embodiment, the rotating information includes rotating angle information. A playing position of the content currently being played may be controlled accordingly.

For example, a playing progress position of a video currently being played may be controlled according to the rotating angle information.

A corresponding relationship between the rotating angle information and the playing progress position may be set in advance. For example, when a rotating angle changes 5 degrees, the playing progress position changes 5% of a total length of the video. After fast forward playing of the video is started, the rotating information may be acquired every 0.5 second, to determine the rotating angle information. For example, when the rotating angle changes 5 degrees every 0.5 second, the playing progress position changes 5% every 0.5 second.

In one embodiment, a rotation may be performed once and ceased. The rotating angle information may be acquired when the rotation is ceased, and the video may be controlled directly to a corresponding progress position according to the rotating angle information. In the embodiment, an initial position of the rotation may be determined at a time when a button event is received.

In one embodiment, the rotating information includes rotating speed information. A playing speed of fast playing the content currently being played may be controlled accordingly.

A corresponding relationship between the rotating speed information and the playing speed of the fast playing may be set ire advance. The faster a rotating speed is, the faster the playing speed of the fast playing is. For example, after the fast playing is started, rotating information is acquired once every 0.5 second to determine rotating speed information. Also for example, if the rotating speed information is 5 degrees per second, the video may be controlled to be played fast forward at a speed of 5% of the total length of the video per second. When the rotation is ceased, the fast playing of the video is ceased, in the embodiment, an initial position of the rotation may be determined at a time when the button event is received.

In one embodiment, the method 100 also includes: during fast playing of the video which is currently being played, a preview image of the video is displayed according to a progress of the fast playing.

Fast playing may be a continuous process. In order for the user to fast learn about general content of the video during the process of fast playing, and to more accurately control the video to be fast played to a desired progress position, the preview image may be provided. The preview image may be a video image extracted from a corresponding fragment of the video being fast played, a thumbnail image of an original video image, or a bottom-layer image of the original video image. Since the user generally does not quire a high quality of the preview image during fast playing, the preview image will be displayed only for a very short moment. By using the thumbnail image or the bottom-layer image, a decompression process of the original video image may be reduced, and the preview image may be fast acquired quickly.

The preview image may be acquired in many ways. For example, a frame of preview image may be acquired every 5 frames of original video images. Alternatively, a frame of preview image at a current playing position may be acquired every 0.5 second. An interval between wo adjacent frames of preview images may be determined by the rotating speed.

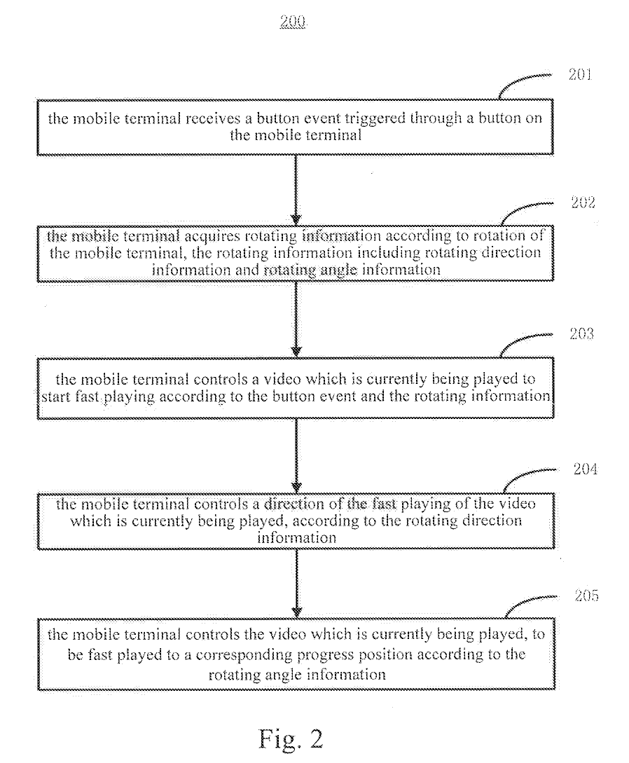

FIG. 2 is a flow chart of a method 200 for controlling a playing state, according to an exemplary embodiment. For example, the method 200 may be implemented by a device with a video playing feature, such as a mobile terminal. Referring to FIG. 2, the method 200 includes the following steps.

At step 201, the mobile terminal receives a button event triggered through a button on the mobile terminal.

At step 202, the mobile terminal acquires rotating information according to rotation of the mobile terminal, the rotating formation including rotating direction information and rotating angle information.

At step 203, the mobile terminal controls a video which is currently being played to start fast playing according to the button event and the rotating information.

At step 204, the mobile terminal controls a direction of the fast playing of the video which is currently being played, according to the rotating direction information.

At step 205, the mobile terminal controls the video which is currently being played, to be fast played to corresponding progress position according to the rotating angle information.

Steps 203, 204, and 205 may be performed simultaneously. Steps 202 and 205 may also be performed repeatedly to implement continuous fast playing. When the acquiring of the rotating information is ceased, or the rotating information is null, or when the triggering of the button event is ceased, the fast playing is ceased.

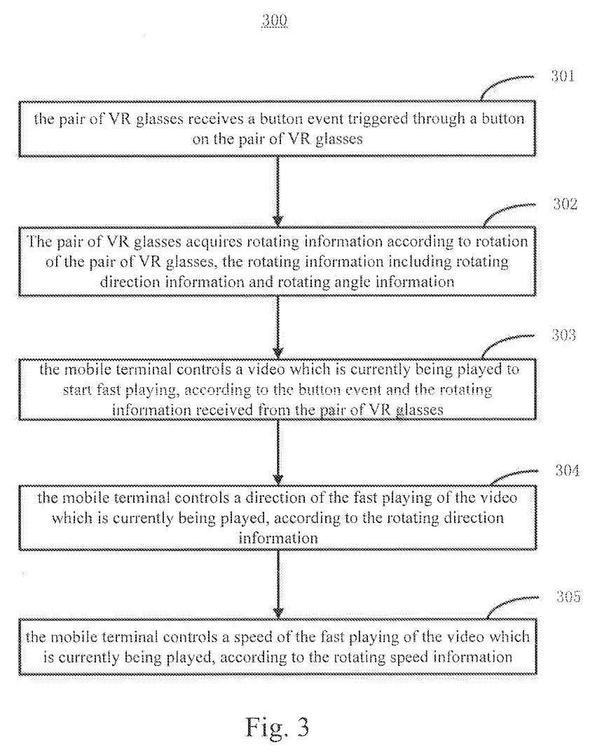

FIG. 3 is a flow chart of a method 300 for controlling-a playing state, according to an exemplary embodiment. For example, the method 300 may be implemented by a mobile terminal and a pair of VR glasses. Referring to FIG. 3, the method 300 includes the following steps.

At step 301, the pair of VR glasses receives a button event triggered through a button on the pair of VR glasses.

At step 302, the pair of VR glasses acquires rotating information according to rotation of the pair of VR glasses, the rotating information including rotating direction information and rotating angle information.

At step 303, the mobile terminal controls a video which is currently being played to start fast playing, according to the button event and the rotating information received from the pair of VR glasses.

At step 304, the mobile terminal controls a direction of the fat playing of the video which is currently being played, according to the rotating direction information.

At step 305, the mobile terminal controls a speed of the fast playing of the video which is currently being played, according to the rotating speed information.

Steps 302 and 305 may also be performed repeatedly to implement continuous fast playing. That is, the pair of VR glasses may continuously acquire rotating information and continuously send the acquired rotating information to the mobile terminal. The mobile terminal may continuously control the fast playing according to the, received rotating information.

With triggering of a button event, the rotating direction may be changed from left to right or from right to left, for e ample, and t necessarily only one direction. Accordingly, the fast playing may be changed from forward to backward or from backward to forward, for example.

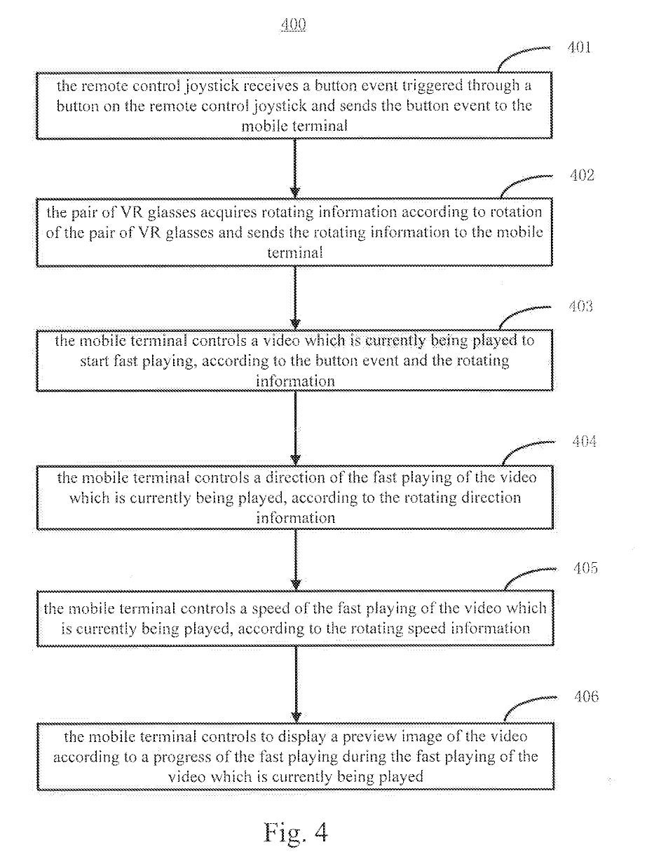

FIG. 4 is a flow chart of a method 400 for controlling a playing state, according to an exemplary embodiment. For example, the method 400 may be implemented by a mobile terminal, a remote control joystick, and a pair of VR glasses. Referring to FIG. 4, the method 400 includes the following steps.

At step 401, the remote control joystick receives a button event triggered through a button on the remote control joystick and sends the button event to the mobile terminal.

At step 402, the pair of VR glasses acquires rotating information according to rotation of the pair of VR glasses and sends the rotating information to the mobile terminal. The rotating information may include rotating direction information and rotating speed information.

At step 403, the mobile terminal controls a video which is currently being played to start fast playing, according to the button event and the rotating information.

At step 404, the mobile terminal controls a direction of the fast playing of the video which is currently being played, according to the rotating direction information.

At step 405, the mobile terminal controls a speed of the fast playing of the video which is currently being played, according to the rotating speed information.

At step 406, the mobile terminal controls to display a preview image of the video according to a progress of the fast playing during the fast playing of the video which is currently being played.

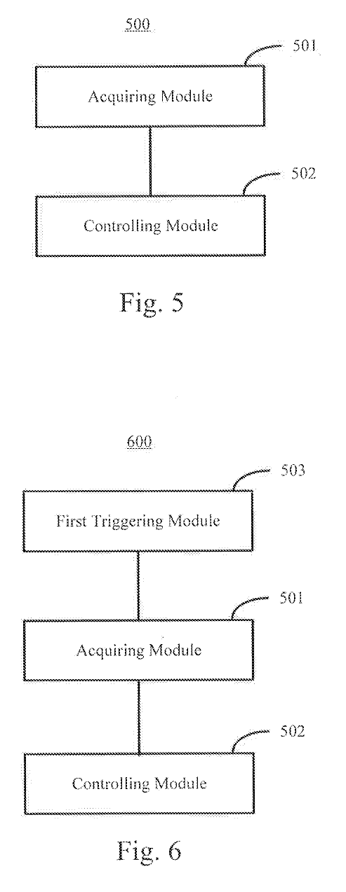

FIG. 5 is a block diagram of a device 500 for controlling a playing state, according to an exemplary embodiment. As shown in FIG. 5, the device 500 includes an acquiring module 501 and a controlling module 502.

The acquiring module 501 is configured to, upon receipt of a starting event triggered by a peripheral component acquire rotating information of a rotated device. For example, upon receipt of a button event triggered by a button, rotating information is acquired.

The controlling module 502 is configured to control a playing state of content Which is currently being played, according to the starting event and the rotating information. For example, a video which is being currently played is controlled to be fast played, according to the button event and the rotating information.

FIG. 6 is a block diagram of a device 600 for controlling a playing state, according to an exemplary embodiment. As shown in FIG. 6, the device 600 further includes a first triggering module 503 in addition to the acquiring module 501 and the controlling module 502 (FIG. 5). The first triggering module 503 is configured to, when the peripheral component is a physical button disposed outside of a housing of a terminal or the smart device, or a physical button on a remote control device bound with the smart device, trigger the starting event by receiving an operation on the physical button.

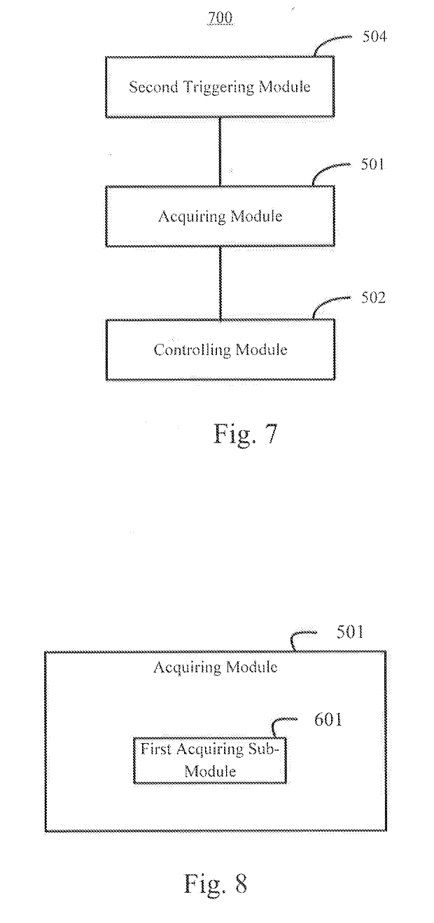

FIG. 7 is a block diagram of a device 700 for controlling a playing state, according to an exemplary, embodiment. As shown in FIG. 7, the device 700 further includes a second triggering module 504 in addition to the acquiring module 501 and the controlling module 502 (FIG. 5). The second triggering module 504 is configured to, when the peripheral component is a virtual button disposed outside of the housing of the terminal or the smart device, or is a virtual button on the remote control device bound with the smart device, trigger the starting event by receiving a touch operation on the virtual button.

FIG. 8 is a block diagram of the acquiring module 501 (FIG. 5), according to an exemplary embodiment. As shown in FIG. 8, the acquiring module 501 includes a first acquiring sub-module 601 configured to acquire the rotating information through a sensor inside the smart device.

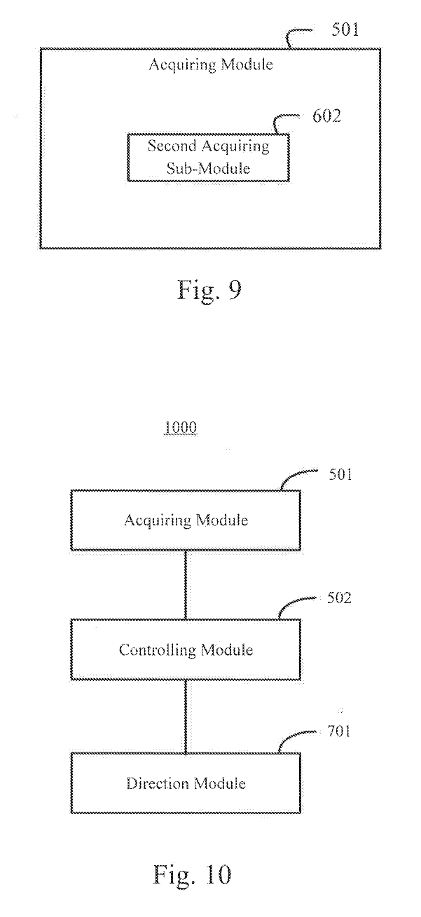

FIG. 9 is a block diagram of the acquiring module 501 (FIG. 5), according to an exemplary embodiment. As shown in FIG. 9, the acquiring module 501 includes a second acquiring sub-module 602 configured to acquire the rotating information through a remote control device bound with the smart device.

FIG. 10 is a block diagram of a device 1000 for controlling a playing state, according to an exemplary embodiment. As shown in FIG. 10, the device 1000 further includes a direction module 701 in addition to the acquiring module 501 and the controlling module 502 (FIG. 5). The direction module 701 is configured to, when the rotating information includes rotating direction information, control a playing direction of the video which is currently being displayed, according to the rotating direction information.

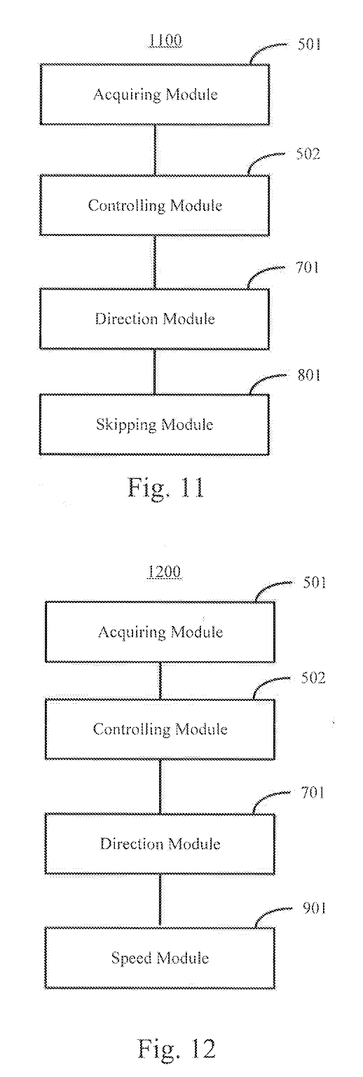

FIG. 11 is a block diagram of a device 1100 for controlling a playing state, according to an exemplary embodiment. As shown in FIG. 11, the device 1100 further includes a skipping module 801 in addition to the acquiring module 501, the controlling module 502, and the direction module 701 (FIG. 10). The skipping module 801 is configured to, when the rotating information includes rotating angle information, control a playing position of the video which is currently being displayed, according to the rotating angle information.

FIG. 12 is a block diagram of a device 1200 for controlling a playing state, according to an exemplary embodiment. As shown in FIG. 12, the device 1200 further includes a speed module 901 in addition to the acquiring module 501, the controlling module. 502, and the direction module 701 (FIG. 10). The speed module 901 is configured to, when the rotating information includes rotating speed information, control a playing speed of the video which is currently being displayed, according to the rotating speed information.

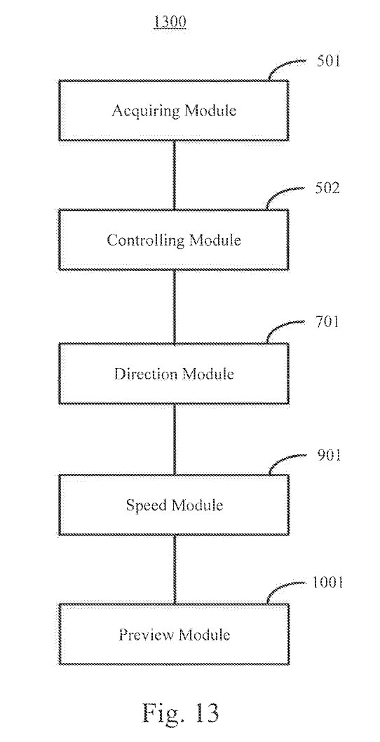

FIG. 13 is a block diagram of a device 1300 for controlling a playing state, according to an exemplary embodiment. As shown in FIG. 13, the device 1300 further includes a preview module 1001 in addition to the modules of the device 1200 (FIG. 12). The preview module 1001 is configured to, during fast playing of the video which is currently being played, display a preview image of the video according to a progress of the fast playing.

With respect to the devices in the above embodiments, the specific manners for performing operations by the individual nodules have been described in detail in the embodiments regarding the relevant methods, which will not be repeated herein.

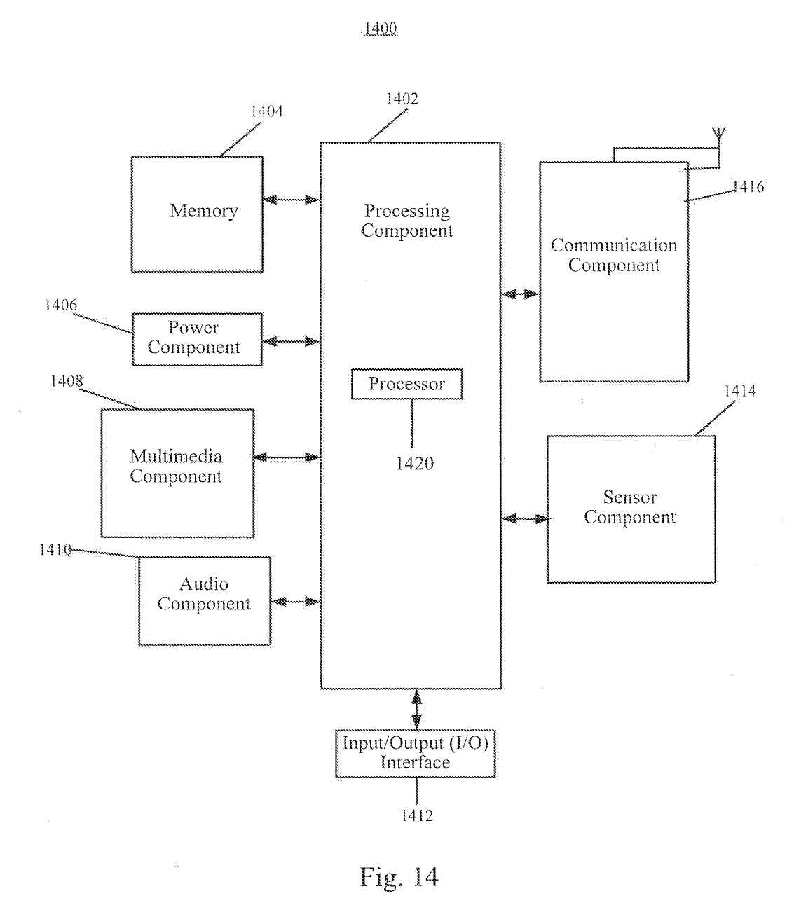

FIG. 14 is a block diagram of a device 1400 for controlling a playing state, according to an exemplary embodiment. For example, the device 1400 may be a smart device or a terminal, such as a mobile phone, a computer, a digital broadcast terminal, a messaging device, a gaming console, a tablet, a medical device, exercise equipment, a personal digital assistant, and the like.

Referring to FIG. 14, the device 1400 can include one or more of the following components: a processing component 1402, a memory 1404, a power component 1406, a multimedia component 1408, an audio component 1410, an input/output (I/O) interface 1412, a sensor component 1414, and a communication component 1416.

The process component 1402 typically controls overall operations of the device 1400, such as the operations associated with display, telephone calls, data communications, camera operations, and recording operations. The processing component 1402 can include ogre or more processors 1420 to execute instructions to perform all or part of the steps in the above described methods. Moreover, the processing component 1402 can include one or more modules which facilitate the interaction between the processing component 1402 and other components. For instance, processing component 1402 can include a multimedia module to facilitate the interaction between the multimedia component 1408 and the processing component 1402.

The memory 1404 is configured to store various types of data to support the operation of the device 1400. Examples of such data include instructions for any applications or methods operated on the device 1400, contact data, phonebook data, messages, pictures, video, etc. The memory 1404 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1406 provides power to various components of the device 1400. The power component 1406 can include a power management system, one or more power sources, and any other components associated with the generation, management, and distribution of power in the device 1400.

The multimedia component 1408 includes a screen providing an output interface between the device 1400 and the user. In some embodiments, the screen can include a liquid crystal display (LCD) and a touch panel. If the screen includes the touch panel, the screen be implemented as a touch screen to receive input signals from the user. The touch panel includes one or more touch sensors to sense touches, swipes, and gestures on the touch panel. The touch sensors can not only sense a boundary of a touch or swipe action, but also sense a period of time and a pressure associated with the touch or swipe action. In some embodiments, the multimedia component 1408 includes a camera and/or a rear camera. The front camera and the rear camera can receive an external multimedia datum while the device 1400 is in an operation mode, such as a photographing mode or a video mode. Each of the front camera and the rear camera can be a fixed optical lens system or have focus and optical zoom capability.

The audio component 1410 is configured to output and/or input audio signals. For example, the audio component 1410 includes a microphone configured to receive an external audio signal when the device 1400 is in an operation mode, such as a call mode, a recording mode, and a voice recognition mode. The received audio signal cap be further stored the memory 1404 or transmitted via the communication component 1416. In some embodiments, the audio component 1410 further includes a speaker to output audio signals.

The I/O interlace 1412 provides an interface between the processing component 1402 and peripheral interface modules, such as a keyboard, a click wheel, buttons, and the like. The buttons can include, but are not limited to, a home button, a volume button, a starting button, and a locking button.

The sensor component 1414 includes one or more sensors to provide status assessments of various aspects of the device 1400. For instance, the sensor component 1414 can detect an open/closed status of the device 1400, relative positioning of components, e.g., the display and the keypad of the device 1400. The sensor component 1414 can also acquire rotating information of the device 1400, and detect a change in position of the device 1400 or a component of the device 1400, a presence or absence of user contact with the device 1400, an orientation or an acceleration/deceleration of the device 1400, and a change in temperature of the device 1400. The sensor component 1414 can include a proximity sensor configured to detect the presence of nearby objects without any physical contact. The sensor component 1414 can also include a light sensor, such as a CMOS or CCD image sensor, for use in imaging applications. In some embodiments, the sensor component 1414 can also include an accelerometer sensor, a gyroscope sensor, a magnetic sensor, a pressure sensor, or a temperature sensor.

The communication component 1416 is configured to facilitate communication, wired or wirelessly, between the device 1400 and other devices. The device 1400 can access a wireless network based on a communication standard, such as WiFi, 2G, 3G, or 4G or a combination thereof. In one exemplary embodiment, the communication component 1416 receives a broadcast signal or broadcast associated information from an external broadcast management system via a broadcast channel. In one exemplary embodiment, the communication component 1416 further includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies. 1001081 In exemplary embodiments, the device 1400 can be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1404, executable by the processor 1420 in the device 1400, for performing the above-described methods. For example, the non-transitory computer-readable storage medium can be a ROM, a RAM, a CD-ROM, a magnetic tape, a floppy disc, an optical data. storage device, and the like.

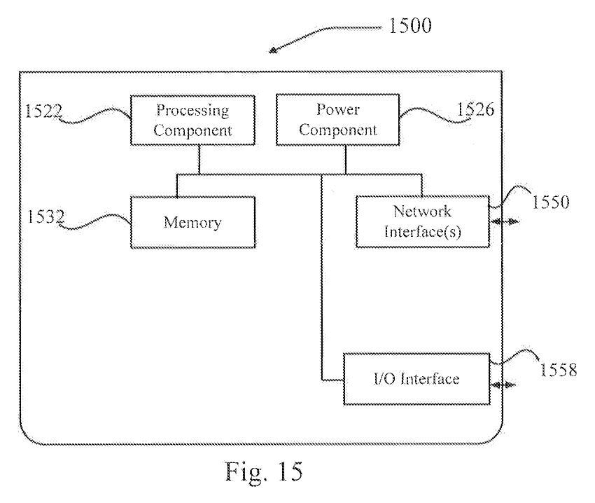

FIG. 15 is a block diagram of a device 1500 for controlling a playing state, according to an exemplary embodiment. For example, the device 1500 may be a terminal.

Referring to FIG. 15, the device 1500 includes a processing component 1522 that further includes one or more processors, and memory resources represented by a memory 1532 for storing instructions executable by the processing component 1522, such as application programs. The application programs stored ins the memory 1532 may include one or more sets of instructions. Further, the processing component 1522 is configured to execute the instructions to perform the above described methods for controlling a playing state.

The device 1500 may also include a power component 1526 configured to perform power management of the device 1500, wired or wireless network interface(s) 1550 configured to connect the device 1500 to a network, and an input/output (I/O) interface 1558. The device 1500 may operate based on an operating system stored in the memory 1532, such as Windows Server™, Mac OS X™, Unix™, Linux™, FreeBSD™, or the like.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for controlling a playing state, comprising:
upon receipt of a starting event triggered by a peripheral component of a smart device, acquiring rotating information of the smart device; and
controlling a playing state of content which is currently being played, according to the starting event and the rotating information.

2. The method of claim 1, wherein the peripheral component is a physical button disposed outside of a housing of the smart device, or a physical button on a remote control device bound with the smart device, and the starting event is triggered by receiving an operation on the physical button.

3. The method of claim 1, wherein the peripheral component is a virtual button displayed on the smart device, or a virtual button displayed oh a remote control device bound with the smart device, and the starting event is triggered by receiving an operation on the virtual button.

4. The method of claim 1, wherein the acquiring rotating information of the smart device comprises:
acquiring the rotating information through a sensor inside the smart device.

5. The method of claim 1, wherein the acquiring rotating information of the smart device comprises:
acquiring the rotating information through a remote control device bound with the smart device.

6. The method of claim 1, wherein when the rotating information includes rotating direction information, the method further comprises:
controlling a playing direction of the content which is currently being played, according to the rotating direction information.

7. The method of claim 1, wherein when the rotating information includes rotating angle information, the method further comprises:
controlling a playing position of the content which s currently being played, according to the rotating angle information.

8. The method of claim 1, wherein when the information includes rotating speed information, the method further comprises:
controlling a playing speed of the content which is currently being displayed, according to the rotating speed information.

9. The method of claim 1, further comprising:
during fast playing of a video which is currently being played, displaying a preview image of the video according to a progress of the fast playing.

10. A terminal for controlling a playing state, comprising:
a processor; and
a memory for storing instructions executable by the processor;
wherein the processor is configured to:
upon receipt of a starting event triggered by a peripheral component to a smart device, acquire rotating information of the smart device; and
control a playing state of content which is currently being played, according to the starting event and the rotating information.

11. The terminal of claim 10, herein the peripheral component is a physical button disposed outside of a housing of the smart device, oar a physical button on a remote control device bound with the smart device, and the starting event is triggered by receiving an operation on the physical button.

12. The terminal of claim 10, wherein the peripheral component is a virtual button displayed on the smart device, or a virtual button displayed on a remote control device bound with the smart device, and the starting event is triggered by receiving an operation on the virtual button.

13. Thee terminal of claim 10, wherein the processor is further configured to:
acquire the rotating information through a sensor inside the smart device.

14. The terminal of claim 10, wherein the processor is further configured to:
acquire the rotating information through a remote control device bound with the smart device.

15. The terminal of claim 10, wherein when the rotating information includes rotating direction information, the processor is further configured to:
control a playing direction of the content which is currently being played, according to the rotating direction information.

16. The terminal of claim 10, wherein when the rotating information includes rotating angle information, the processor is further configured to control a playing position of the content which is currently being played, according to the rotating angle information.

17. The terminal of claim 10, wherein when the rotating information includes rotating speed information, the processor is further configured to:
control a playing speed of the content which is currently being played, according to the rotating speed information.

18. The terminal of claim 10, wherein the processor is further configured to:
during fast playing of a video which is currently being played, display a preview image of the video according to a progress of the fast playing.

19. A non-transitory computer-readable storage medium having stored therein instructions that, when executed by a processor of a terminal, cause the terminal to perform a method for controlling a playing state, the method comprising:
upon receipt of a starting event triggered by a peripheral component of a smart device, acquiring rotating information of the smart device; and
controlling a playing state of content which is currently being played, according to the starting event and the rotating information.
